(19) United States
(12) Patent Application Publication
(10) Pub. No.: US 2014/0058954 A1
(43) Pub. Date: Feb. 27, 2014

(54) Searchable Matching System and Method with Customizable Profiles and Unique Pre-Interview Negotiation Method

(71) Applicants: Merav Yonit Perlstein, Ambler, PA (US); Itay Perlstein, Ambler, PA (US)

(72) Inventors: Merav Yonit Perlstein, Ambler, PA (US); Itay Perlstein, Ambler, PA (US)

(21) Appl. No.: 13/970,543

(22) Filed: Aug. 19, 2013

Related U.S. Application Data
(60) Provisional application No. 61/692,370, filed on Aug. 23, 2012.

(51) Int. Cl. G06Q 10/10; G06Q 50/18

(52) U.S. Cl. CPC G06Q 10/1053; G06Q 50/188
USPC 705/80

(57) ABSTRACT

A searchable matching system and method with customizable profiles and pre-interview negotiation bidding is provided. The system comprises a central website connected to a database of multimedia data related to end users customizable profiles and listings. Pre-matched searchable fields, used in profile creation facilitate matching of end users with the maximum relevancy of fields, and search results are ranked. The system includes communication, interviewing, and scheduling modules. End users negotiate terms of an agreement through placing and/or receiving bids upfront before interviewing, wherein bid terms limit the scope of the potential agreement, which can be accepted by end users making the terms of said bids binding for future negotiations. Only when users enter into a final agreement will final terms of negotiation bids become binding upon all users. Preferred industries include job placement services, landlord and tenant matching services, travel services, or real estate finding services.

### CROSS-REFERENCE TO RELATED APPLICATIONS

This application claims priority of U.S. Provisional Application Ser. No. 61/692,370, filed on Aug. 23, 2012, titled ‘Searchable Matching System and Method with Customizable Profiles and Unique Pre-Interview Negotiation Method,’ which application is incorporated in its entirety by reference in this application.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### FIELD OF THE INVENTION

The present invention is in the technical field of matching systems and methods for matching end users. More particularly, the present invention is in the technical field of computer, Internet and network based matching systems and methods, with multimedia profiles, postings and searchable features for both parties being matched.

### BACKGROUND OF THE INVENTION

Conventional computer based matching systems provide for users to create profiles, answer questions to generate data to be matched and to run searches to find other parties that may be an ideal match. Such computer based matching services often require users to answer questions and fill out rigid profiles, where there is little room for personalization of the overall appearance of their profile page or including multimedia, such as videos. Further, negotiations, if any, through these matching sites always happen after the parties, such as a job seeker and an employer, a landlord and a tenant or a traveler and an airline/hotel, agree to engage each other's services or enter into an agreement.

### Current Employment System Landscape

Conventional computer based employment systems and methods allow for employers to post positions, to which job seekers can apply. Sometimes job seekers simply post a resume, and other times, they may undergo a lengthy application process to address an employer's questions concerning qualifications, past experience and other employment relevant information.

Job seekers resumes and application materials can be stored electronically, allowing for employers to search for qualified candidates, using different search criteria using keyword searches. Further, job seekers can use keyword searches, such as to specify location or position type to search through a database of jobs posted and stored on the computer, Internet and network based employment system. Ultimately, traditional employment systems and methods are inefficient for many reasons, especially in certain industries.

### Job Board Marketplace

Currently, many job openings are posted on websites called “job boards”, where jobs are listed, and job seekers search for and may apply to jobs posted. Under the job board model, a potential employee often needs to tailor his/her resume again and again to fit multiple job descriptions and rarely hears back. The job application process is often extremely time consuming, and when a job seeker finally gets an offer, in many cases it is not what he or she was expecting. Employers on the other hand, are bombarded with hundreds of resumes in response to a job listing, most of which are not relevant to their employment needs.

One of the major challenges of finding jobs on job boards for job seekers is that only a very small percent of the jobs in the marketplace are actually advertised, wherein the majority of available jobs are not. Many available jobs are only advertised to recruiters or advertised internally in the companies, meaning job seekers do not have direct access to most of the jobs available. At the same time, recruiters and employers look for the best candidates, aware that most of the candidate pools do not come from the active seekers, but are composed of a pool of passive seekers who are employed, and passively open to new opportunities. Unfortunately, under this current marketplace reality, there is a dual sided issue, where job seekers look for, but cannot find, the majority of the best jobs, and likewise, employers cannot find many qualified candidates because a passive job seeker who could be the best company fit does not apply on job boards.

In the current job board market, both employers and job seekers are searching for each other, and both are having a difficult time finding the appropriate match. This leads to frustration and huge waste of time on both sides of the employment process: job seekers apply to any job that remotely describes their qualifications, even if they do not fit the requirements, and employers are bombarded with hundreds of resumes, unable to sift quickly through all of them to find the ones that really fit their needs. Under the current system both parties waste time and miss out on great opportunities.

In many traditional web based employment systems, positions are posted and connect to the job posters' individual websites, redirecting job seekers and often causing them to have to fill out lengthy applications, for which the job seeker must tailor his or her resume, cover letter, or other application materials multiple times. Applicants often must tailor application materials multiple times, even when the employment system allows the job seeker to save versions of resumes or cover letters for job applications, since resumes and cover letters only can contain a limited amount of information and must therefore be focused to highlight the job seeker's qualifications and accomplishments that would make him or her particularly well suited to the position for which he or she applies. Some traditional job search engines allow resumes and application materials to be saved in the employers' database and searched for potential future use, but the employers may miss an ideal candidate for multiple reasons, including that the resume was tailored to another position and the search function may miss candidates that failed to use certain key terms in their application materials.

### Inefficient Time Consuming Process

The process of finding a new job through conventional computer, Internet and network employment systems is often extremely difficult, and time consuming. In the current online job marketplace, job seekers have to go through a long process of searching for jobs, filling out lengthy applications, researching companies, and submitting resumes. Applicants often have to write, edit and tailor their resumes to fit the requirements of each job posting on each of the websites, and in addition, many of the jobs require a separate application to be filled as well, so the applicant will be entered into their database in a searchable way.

Job seekers spend time searching multiple websites and applying to jobs that they later learn no longer exist because the positions were filled, but the website was never updated. Since many websites are aggregators of jobs, the websites do not necessarily know when a job is filled or cancelled. Job seekers often spend days or weeks, applying to jobs, only to never receive a response, because their applications were received too late and were never read or seen. This leads to a lot of frustration and wasted time.

Often job applicants must travel for interviews, possibly taking off of work and incurring travel expense, only to learn that the position to which the applicant applied does not satisfy the applicant's desired qualifications, such as salary, hours, schedule or position type. The current process leaves the most important basic details to the end of the hiring process, which is not efficient nor does it make sense for either parties.

Not only are conventional computer, Internet and network systems often difficult and time consuming to use for job applicants, but they are also often difficult and time consuming for employers to use. Employers often have a difficult time finding desirable candidates for positions since applicant information is not submitted in a uniform manner for each resume. Therefore, an employer must enter a keyword, keywords or Boolean searches with operators such as AND, OR and NOT, to search through a vast volume of resumes and applicant information. If, in his or her application materials, a job seeker does not use the same keyword to define a skill or qualification, the employer could entirely miss an ideal candidate for the position. This results when employers use the search filters provided by the electronic search engines to add their own key words according to their specific job requirements. If an ideal candidate did not know to include these specific key words in her application materials, her resume will not be highlighted in the employers' search results as an ideal match, ultimately causing employers to miss out on great candidates and causing candidates to miss great opportunities.

Employers, waste time sifting through hundreds of resumes and profiles, trying to find the few job seekers that really match their needs. In this process, employers are in a mode of ‘screening out’ rather than focusing on finding a candidate with the right qualifications and skills, often encountering hundreds of applications from people who do not even fit their job requirements. After reviewing voluminous applications, many other applications go unread due to time constraints and employers miss out on great candidates. In addition, employers waste a great deal of time on phone interviews and cold calls, to reach passive job seekers on current job websites to obtain more information from applicants, because there is currently no electronic option to communicate directly to obtain the requested information from passive seekers.

Candidates Find it Hard to Get Noticed

Since there are so many job seekers applying for the same job posted, it has become extremely difficult for job seekers to stand out in the crowd, especially with a standard black and white resume. In today's marketplace job seekers are still asked to submit a resume, written according to specific rules and format, which causes all resumes to look and sound the same, especially when submitted in the same industry, or tailored for the same job. Job seekers have a hard time showing their special skills, achievements, and specific experiences, and even character, in a dry factual standard file. In turn, employers also have a hard time distinguishing the right candidates to interview from the piles of similar resumes. After reviewing dozens of resumes, employers find it difficult to see the differences, and many ignore the rest of the pile, causing many potential missed opportunities.

Under the current Internet based employment process, job seekers are forced to be job chasers, in order to get an interview or to stand out. They must repeatedly search for and find the jobs, tailor their resumes, apply, follow up, and interview. Although some social media sites, such as LinkedIn®, allow professionals to create profiles, listing employment qualifications, experience, education and awards, which may be searchable by employers, these sites were not intended to specifically match job seekers with employers. As such, these systems were not designed with specialized search functions, and individual users were not prompted to create profiles utilizing critical key language, effectively allowing for employers' searches to miss ideal candidates.

### Negotiations are Discussed Too Late in the Process

In almost every job seeking blog, consulting service, or article, job seekers are advised to delay salary discussions until the very end of the long application and interview process, when the formal offer is made. Even when asked about salary expectations early on in the process, job seekers are advised to postpone the answer or try to give a vague response, until they are chosen and have a formal written offer. At this point, it is very hard to significantly change the offer. Many of the job seekers are screened out immediately because they cannot or will not provide their salary expectations in preliminary interviews. However, many of the job seekers who do respond with a salary are also screened out because the number is too high or too low for a specific employer. When negotiations are very late in the process, after multiple interviews, and hours of job hunting, if the offer is not acceptable to either party, walking away from the employment agreement translates to a huge waste of time and money for everyone involved. This is in part due to the fact that in today's marketplace the main way employers go about finding out this information is by asking the job seekers to provide salary expectations first. Candidates often feel uncomfortable answering and many are afraid to miss the opportunity and give a too low a number, just to ensure they move on to the interview phase. Further, employers often post job listings with salary ranges, which provide little room for negotiations between candidates with potentially large degrees of difference in experience and qualifications.

In the current job market place, there is a need for an Internet based employment system where employers and employees are able to negotiate critical aspects of the employment relationship earlier in the process to save all parties time and money, and to provide flexibility to accommodate for different job seekers skill sets.

Since many computerized employment systems simply redirect job seekers to employers' individual websites, anyone with Internet access can apply for jobs, regardless of whether they are qualified for the position, requiring employers to search through many resumes, creating a lengthy review process to find the ideal candidate, since the information is not necessarily all in the same format. After lengthy searching and sifting through resumes, employers may interview candidates only to find out that the candidates may require more than the employer is willing to offer, such as candidates that are only willing to work for a salary greater than what the employer is willing to pay. If this occurs, not only was the employer's time wasted, but the employer then must search back through the resumes collected. If time has passed by, as often is the case, the employer may have lost out on an ideal candidate who would fit all aspects of the position, while the employer was interviewing other candidates, who wanted more than the employer was able or willing to offer. Further, in the current interview process employers often waste their own time and resources, as well as the resources of their teams through scheduling day long interviews, not to mention covering the travel costs involved in travel of candidates to interviews. Employers also miss out on candidates who were screened out for answering the salary expectation question with too high or too low of a response.

By putting off making offers until the end of the employment process, employers often fail to find the best candidates for the best price. This is due to the approach employers take in making offers by basing them on candidates' expectations and prior experience. For example, since employers are unaware what the lowest acceptable salary for a good candidate would be, they often estimate a salary based on the employers own experience, losing not only candidates, but also money. In addition, many employers use expensive recruiters to find and hire talent, including passive job seekers, but this approach is very costly and often does not provide the employer with direct access to the pool of candidates profiles.

The problems outlined above in relation to matching job applicants and employers in the job industry are similar to issues encountered in other industries. Many services and industries would benefit from a new process that allows upfront negotiations, and easy searches to be performed by both parties of a transaction or relationship.

### Other Industries: Real Estate, Landlord/Tenant, Travel Industry

Currently, there are no computer based matching systems where landlords can find tenants and reach out to them directly or where people selling homes can reach out to potential home buyers to showcase their properties. What exists in the marketplace for rentals and home sales are search engines containing lists of properties, which individuals looking to buy a home or looking to rent must search through. No negations occur through the online search systems, either.

Similarly, in the travel industry, individuals wishing to travel must spend time and energy searching for deals. Most common computer based resources include large search engines, which compare rates of hotels, airlines and travel packages. Although subscribers can be put on mailing lists to receive updates on travel deals, there are no computer based travel services that allow companies to find travelers based on their profiles and negotiate rates. Most industry rates tend to be fixed rates in the current marketplace.

Therefore, there is a need for a more efficient computerized matching system for both parties of a transaction-to efficiently find the ideal match for their needs and have an opportunity to be approached by the other party, negotiating important details before the parties invest significant time and resources.

### SUMMARY OF THE INVENTION

The present invention is an Internet based computerized system and network platform for allowing parties to connect with one another. More specifically, the present invention is an Internet based system wherein users can create customized profiles, including multimedia application materials, such as text, audio and video information, to allow other users to get a better understanding of their skills, qualifications, backgrounds and other relevant information to the potential transaction and negotiate important information upfront, before interviewing or making a final offer without an interview.

The present invention allows end users to use pre-determined filters to create profiles. Profiles can be personal, professional, a job profile, a property profile, a travel package profile, a hotel profile or any data that concerns a person, entity, sale or rent which bids can be placed upon for work, rent or purchase. The present invention also allows end users to search using pre-determined search filters that match with pre-determined filters used in creation of profiles. The present invention allows different categories of end users to search for one another using the same pre-determined filters to facilitate matching. For example, pre-determined search filters will assist matching the most relevant job seeker to the most relevant job posting based on the pre-determined filters implemented in creation of the job seeker's profile and pre-determined filters implemented in creation of the job listing profile. Similarly, pre-determined search filters will assist matching the most relevant tenant to the most relevant property based on the pre-determined filters implemented in creation of the tenant's profile and pre-determined filters implemented in creation of the rental property listing profile. In the current job example, the different categories of end users are the job seeker and the employer/job provider, and the in the landlord/tenant context, the landlord is one category of end user and the tenant is another category of end user. These examples are just illustrative examples, as this method and system can be implemented in many different industries and environments, and are in no way intended to limit the scope of the present invention.

In the job market embodiment of the present invention, job seekers can create custom profiles through the system using multimedia data, such as videos, photos, audio recordings, interactive samples of work, and design their profile in order to personalize it and give potential employers a broad understanding of what they have to offer. Further, the present invention allows job seekers to know critical job information before the interview, such as salary information and position information. Through the use of multimedia, the present invention allows job seekers to create a unique profile. Companies can use multimedia to better display their products, services or career benefits to entice potential employees.

In the present invention, a more efficient job search and employment system is described. Job seekers can create a detailed profile with work examples, awards, portfolio, description of their relevant experiences, skills, responsibilities, qualities and even a personal video, instead of a plain black and white resume. Employers have the capacity to search for potential employees and view the multimedia profiles. However, unlike employment systems or resume postings in job boards of the prior art, the present invention utilizes filters that employers can implement to look for talent, wherein the filters are pre-matched to the fields that are completed in the employee profile. This makes it easier for employers to find the right fit for the position. The job market embodiment of the present invention provides a system and method that can be used to fill part time, full time, temporary, freelance and full time permanent positions.

While many conventional websites offer a list of profiles/resumes, often these profiles were created independently of any search filters that employers can use to search for employees through those employment systems, allowing for employers to miss an ideal candidate when searching for applicants. However, the present invention provides a platform for job seekers to create profiles in a way that matched the employers' search filters. Through the use of the present system, even when an employer is writing a job description, the employer is aware what key words to use to attract the most relevant candidates. Since the system provides pre-designed profile questions to fit with the search filters, the system provides for maximum match effect. Similarly, employer profile and job descriptions are designed to match job seekers search filters, so job seeking candidates can easily find matching job results to apply to through the system. Further, the system implements a feature where both job seekers and employers are informed of the top key words used in their field each day, to maximize their search results through use of the same words. This process saves both job seekers and employers a lot of time and enables a much better match for the employment position. Therefore, when searching through job applicants and other job seekers in the employment system, employers can use the filters to identify a complete list of qualified job candidates, without missing ideal applicants due to search functions and keywords. This also eliminates the problem employers currently encounter when search results provide too many matching applicants that are not a close fit for the employers desired candidate qualifications, since in the present invention only the few job seekers applications that closely match the employers search requirements are presented in the matching queue.

Further, the present invention provides a new computerized job search and posting system where job seekers and employers can negotiate and agree on certain parameters of employment, such as a salary range, before an interview takes place and before both employers and job seekers waste time and money on a potentially long process. Through the novel system, employers can bid on potential employees they are interested in, negotiate the best salary range for both job seekers and employers, and only then schedule an interview either in person or through the system, or make a final offer without an interview if employers choose to do so. The system allows for video conferencing, and video interviews.

Similarly, through the present invention job seekers can bid on jobs they find stored and publicly posted on the employment system. Job seekers can be competitive, negotiate and agree on specific job parameters, such as a salary range, job title, benefits and etc., with the potential employer before the interview. If a job seeker's offer is not accepted by the employer, or an employer's offer is not accepted by a job seeker, the system will notify the bidder of the denial of his or her offer, no interview will be scheduled, and the offer will be closed and stored in a database, including the terms of the bid made. Both job seekers and employers have access to stored prior offers. Once an offer is rejected, the bid is closed, however, employers may continue communications through the messaging system and may open a new bid under a different job name and restart the negotiation process with the same job seeker. All offers, accepted, negotiated or rejected, expire after a certain predetermined amount of time, so job seekers do not have to wonder and wait for responses that will never come: Accepted offers that do not result in interviews, and/or result in interviews that are not fruitful (i.e. do not end with a hire) will expire automatically after a certain predetermined amount of time from the last negotiation, or the day on which the interview date was agreed and scheduled. A negotiated bid that was abandoned, and has no response by either side, will automatically expire after a certain predetermined amount of time after the last counter offer. An expired offer therefore represents a negative response, yet provides parties with finality, so they are not left wondering or waiting for a response.

Once an offer for an interview is accepted, employers schedule the interview by suggesting options for dates and times and if the interview will be in person (meeting/ phone) or through the system. Scheduling the interview may be done through the website with a calendar that the employer sends to the candidate. The date confirmation can be sent via confirmation e-mail. The interview itself can also take place online through the website, through which both parties can communicate. Only after the interview, if both the job seeker and the employer are still interested in the hire, the initially accepted offer in the system becomes final. If either the job seeker or the employer is no longer interested in the other party in reference to the position, then no employment arrangement is entered into by the parties.

In contrast to the prior art, in the present invention, the bid for employment does not have to close through the system. Instead, both the employer and the job seeker enter into a user agreement with the employment system, binding upon sign up, where all parties agree to honor an accepted offer if both the employer and the job seeker are interested in the hire, only after the interview process. Both the employer and the job seeker can make offers (bids) but do not have to choose one partner and close the deal through the system. This process allows the employer and the job seeker to negotiate and agree on the terms of an offer before the interview. However, the terms agreed upon prior to the interview, including salary or job title, would only take effect once both employer and job seeker make a decision on the final candidate or to work for the employer, respectively, either after the interview process, or after the employer makes the final hiring offer in the event that the parties enter an employment agreement without engaging in interviewing. The final hiring agreement, however, will be pursuant to the terms agreed upon through bidding prior to the interview process. Therefore, the present invention saves time for both employers and job seekers, not by eliminating the negotiation process, but by having it much earlier in the process, prior to investing time on interviews of candidates that would ultimately want a position with different terms of employment.

This invention also saves the employer time and money by eliminating the need for employers to invest in expensive research to estimate accepted salaries in their field, guessing what candidates would accept, or asking candidates for their salary expectations not knowing if these expectations are the actual figures that these candidates would be willing to accept. By providing the unique upfront negotiation feature, the present invention allows the parties to agree on important job details, such as the acceptable salary, preventing employers from eliminating great talent who stated salary expectations exceeding the employer' set budget when candidates would have accepted less, and saves both parties from wasting money on research. In turn, the present invention allows employers to initiate a bid they feel comfortable with, and negotiate the bid to an acceptable range for both parties, which in many cases, would still be lower than industry standards or stated expectations of job seekers when asked. Employers can also use search features of the system of the present invention to compare candidates and to learn what are the acceptable offers and going rates in their field. Although employers may search and compare multiple bids, all negotiations through the system are private and strictly confidential between the parties.

Since the current process allows for flexibility of negotiation, employers and job seekers can bid on multiple partners (potential employees or jobs, respectively), accept multiple bids through the employment system and interview multiple candidates for the same job or be interviewed as a candidate for multiple jobs. The applicants or employers are not bound until after both parties agree to the final offer after the interview process takes place or the final offer is accepted in the case where the parties decide to enter an employment agreement without interviewing. This built in flexibility of the system allows for quicker matching of ideal candidates to ideal positions, since parties can obtain a complete understanding of what other parties have to offer upfront. This streamlines the process in that candidates and employers are aware of the terms of the agreement and what the other has to offer, so interviews will focus on learning about one another and only take place between parties that are entirely interested in the entire arrangement, rather than interviews serving the purpose of finding out critical details, such as salary requirements. This approach creates a balance of power between employers and potential employees by providing potential employees with the advantage of being able to negotiate multiple offers, and allow employers to approach candidates and disclose terms of the employment agreement, such as salary, upfront.

Passive job seekers, who are currently employed, but who are open to new opportunities, also benefit from the present system, by creating profiles on the system, which are searchable by employers. The present invention allows a job seeker to designate the status of his or her profile as either an active job seeker looking for a job, or as a passive seeker, who is currently open to opportunities.

The advantages of the ability to be categorized as a passive versus an active seeker include that many employers prefer passive job seekers due to their experience and qualifications, and this system makes it extremely easy for employers to determine the seekers active or passive status. In addition, when employers are interested in highly experienced and sought after passive candidates, who are hard to reach, they can use this system to attract their attention with the right bid. Alternatively, employers may be looking for candidates who are actively looking, available to start a new job immediately, and more open to consider lower offers than passive seekers who may prefer higher salaries to convince them out of their current employment arrangements and who may not be able to start immediately. For employers, the system opens the candidate pool to passive seekers, and they can attract them with offers directly, without having to approach them through the use of expensive recruiters or through the complexity of social networking sites.

Employers using the system benefit by the advantage of a simpler process, which provides substantial time savings by getting the negotiation process out of the way early and knowing on which candidates to invest their time. Further, employers have the opportunity to provide different candidates with different offers according to their interest in specific candidates, rather than placing static terms of employment, such as a flat rate or position description for all candidates. This feature of the present invention allows employers to be able to attract the best candidates and to communicate with candidates, attracting great talent to the position.

Although the embodiment discussed above outlines the present invention in the job placement embodiment, the system is well suited for many other services and industries. Of these include, but are not limited to the real estate market and landlord/tenant matching services, and travel matching services.

Landlords want to find tenants with certain qualifications, including tenants who are reliable, have good credit, no evictions or criminal activities in their past, hold a steady job and other relevant qualifications. In the landlord tenant embodiment of the present invention, landlords are able to view tenants' profiles, without names at first for privacy, with tenants' description of themselves, credit scores, reasons for credit scores being low, if tenants have a steady job, for how long they have rented before, recommendations/references, what tenants are looking for in housing and for how long a contract, pets, and etc. Tenants can add a budget range on their profiles if they chose. In the present invention, landlords can conduct a search, where profiles are designed to match search filters and keywords, and will be able to view these profiles and decide which is worth bidding on. For example, once they identify the best tenants, landlords can place a bid for a monthly rent. Landlords are able to add text and negotiate the rent and deposits, or other details all through the system of the present invention. Only after the tenant had an opportunity to view the living place, and the landlord received all proof he or she needs about the tenants background, and both parties are still interested, the accepted offer becomes final.

In this embodiment of the system, landlords will also be able to remain passive, providing profiles with descriptions, pictures and videos of their properties for tenants to place bids on. Landlords will be able to describe what they are looking for in a tenant, and a starting budget. Properties can be categorized as “on the market” or “tenant occupied until XX date”, so landlords can get offers even while tenants are still living in the property, or are on a month-month basis. Further, in the system of the present invention tenants can choose to be “active seekers” when they want to move in to a new place in the near future, or “passive seekers,” for example when their need is less urgent and they are open to hear about deals.

Similarly, through the system tenants are able to view Landlord profiles, including multimedia data, such as pictures, videos and descriptions. Tenants are also able to send a bid on properties for monthly rent. In the same way as landlords, tenants can upload their own profile and wait passively for bids from interested landlords who have properties to occupy. Negotiations in the system allow the landlord and tenant to agree on the monthly rent before the showing or meeting, where acceptance of a bid in the system will lead to a showing and may lead to a lease if both parties are interested. Both landlords and tenants can place multiple bids, at the same time. The system is designed to make the current process simpler and save time and money: not meeting people who are not a good fit, not running credit reports multiple times, not paying for credit checks multiple times, and etc.

Although these embodiments have been explained in detail, the system has implications in many other industries and markets, including but not limited to the travel and real estate markets. The system would work the same way, allowing for multimedia data use, profiles, upfront negotiations, pre-defined search filters and the opportunity for both parties to place multiple bids at the same time. The invention should therefore not be limited by the above described embodiment, method, and examples, but by all embodiments and methods within the scope and spirit of the invention as claimed.

### BRIEF DESCRIPTION OF THE DRAWINGS

FIG. 1 is a flow diagram of an embodiment of the overall layout of user access and connection to the Internet of the present invention; and

FIG. 2 is a flow diagram representing an embodiment of the system process consistent with the present invention; and

FIG. 3 is a flow diagram representing an embodiment of the process of the present invention from the user home page before and after registration in the system; and

FIG. 4A is a flow diagram representing an embodiment of the present invention process from the perspective of a guest, non-registered user job seeker; and

FIG. 4B is a flow diagram representing an embodiment of the present invention process from the perspective of a guest, non-registered user employer; and

FIG. 5 is a flow diagram representing an embodiment of the registration process the present invention from the perspective of a job seeker; and

FIG. 6 is a flow diagram representing an embodiment of the registration process the present invention from the perspective of an employer; and

FIG. 7 is a flow diagram representing an embodiment of the system of the present invention from the access of a registered employer user; and

FIG. 8 is a flow diagram representing an embodiment of the system of the present invention from the access of a registered job seeker user; and

FIG. 9 is a flow diagram representing an embodiment of the search process of the present invention from the perspective of a job seeker; and

FIG. 10 is a flow diagram representing an embodiment of the search process of the present invention from the perspective of a job seeker; and

FIG. 11 is a flow diagram representing an embodiment of the bidding process of the present invention from the perspective of an employer user; and

FIG. 12 is a flow diagram displaying a broad overview of an embodiment of the negotiation process of the present invention; and

FIG. 13 is a flow diagram representing an embodiment of the negotiation process of the present invention from the perspective of an employer user; and

FIG. 14 is a flow diagram representing an embodiment of the negotiation process of the present invention from the perspective of a job seeker user; and

FIG. 15 is a flow diagram representing an embodiment of the scheduling process of the present invention from the perspective of an employer user; and

FIG. 16 is a flow diagram representing an embodiment of the online interview process of the present invention; and

FIG. 17 is a flow diagram representing an embodiment of the offline interview process of the present invention and optional online system process.

### DETAILED DESCRIPTION OF THE INVENTION

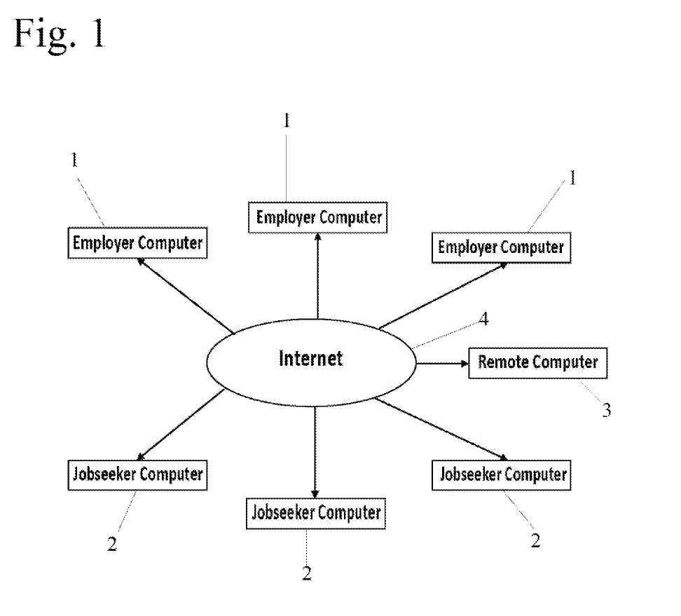

Referring now to the invention in more detail, FIG. 1 is a flow diagram of the overall layout of user access and connection to the Internet of the present invention. In this embodiment, employer computers 1, and job seeker computers 2, connect to the Internet 4 with the database and process running from a remote computer 3.

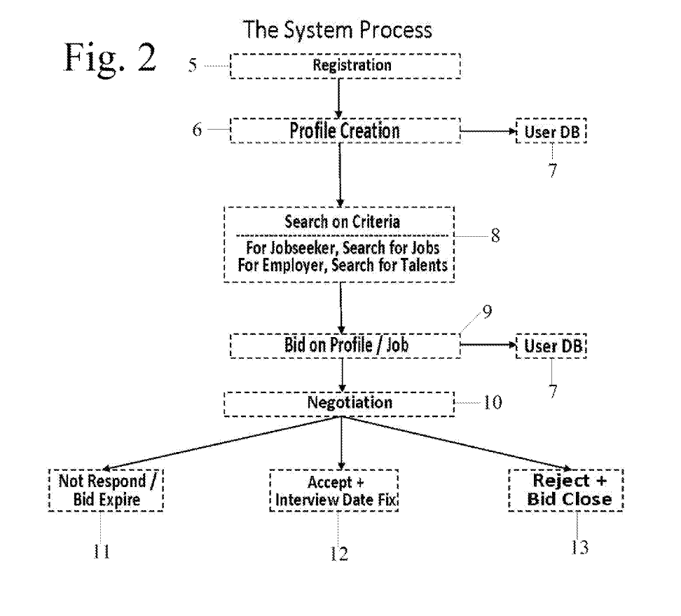

FIG. 2 is a flow diagram representing an overview of an embodiment of the system process consistent with the present invention. Through this embodiment of the system, first a user registers through the system registration 5. The user creates a profile 6 which is stored in a database 7. After the user profile is created 6, the user can search on criteria 8, such that job seeker users can search for jobs and employers, and employer users can search for talent and job candidates. After searching on criteria 8, the job seeker can bid on a job profile and an employer can bid on a job seeker profile, 9 where bids are stored in the system database 7. Once bidding has taken place, negotiations 10 can take place through the system, with outcomes of the other party not responding, allowing the bid to expire 11, accepting the bid and fixing a date for interviewing 12, or rejecting the bid, where the bid closes in the system 13.

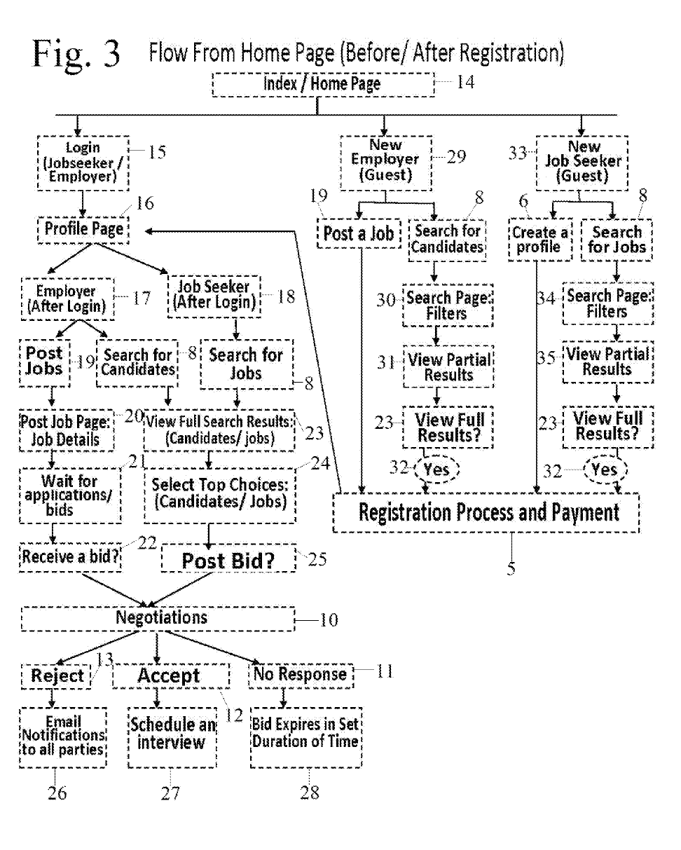

An embodiment of the process of the present invention from the user home page before and after registration in the system is displayed in FIG. 3. In this embodiment, users access the system from the index and home page 14. Registered users can login 15 to obtain full access of the system, whereas guest employer users 29 and guest job seeker users 33 can gain limited access to the system. Registered job seekers and employer users can login 15 to the system, placing users at their profile pages 16. Employer after login 17 can post jobs 19 or search for candidates 8. If posting a job or jobs 19, employers gain access to job posting pages where they can fill in their job details 20. After jobs are posted in the system, employers wait for applications with bids 21. If the employer receives a bid, the negotiation process 10 is initiated, where users can reject 13 offers, where the other party will receive an e-mail communication 26, accept 12 offers to schedule interviewing 27 or if parties do not respond 11, the bid expires in a length of time 28 through the system. Logged in employers 17 can also search for candidates 8 through the system, and has access to view full search results of candidates 23. Employers can select top candidate choices 24, and bid on candidates 25, initiating the negotiation process 10 where users can reject 13 offers, where all parties will receive an e-mail communication 26, accept 12 offers to schedule interviewing 27 or if parties do not respond 11, the bid expires in a length of time 28 through the system.

In this embodiment, logged in job seekers 18 can search for jobs or employers 8, to view full job search results 23, select top job choices 24, and can post a bid on a job 25, initiating the negotiation process 10 where users can reject 13 offers, where the other party will receive an e-mail communication 26, accept 12 offers to schedule interviewing 27 or if parties do not respond 11, the bid expires in a length of time 28 through the system.

FIG. 3 also shows that new or guest employers 29 and job seekers 33 can access a limited version of the system, which can be unlocked to gain access to the entire system through registration. In this embodiment, a guest employer 29 can choose to post a job 19 or search for candidates 8, access a search page with predefined search filters 30 to view partial search results 31. If the guest employer user 29 would like to view full results 32 or post a job 19, the system forwards them to full registration and payment information 5, where the employer user can become a registered user 17 and follow the process outlined above. Similarly, in this embodiment a new or guest job seeker 33 can choose to create a profile 6 or search for jobs 8 and access a search page with predefined search filters to match job descriptions and keywords 34 to view partial search results 35. If the guest job seeker user 33 would like to view full search results 32 or create a profile 6, the system will forward them to full registration and payment information 5, where the job seeker user can become a registered user 17 and follow the process outlined above to gain access to the full system.

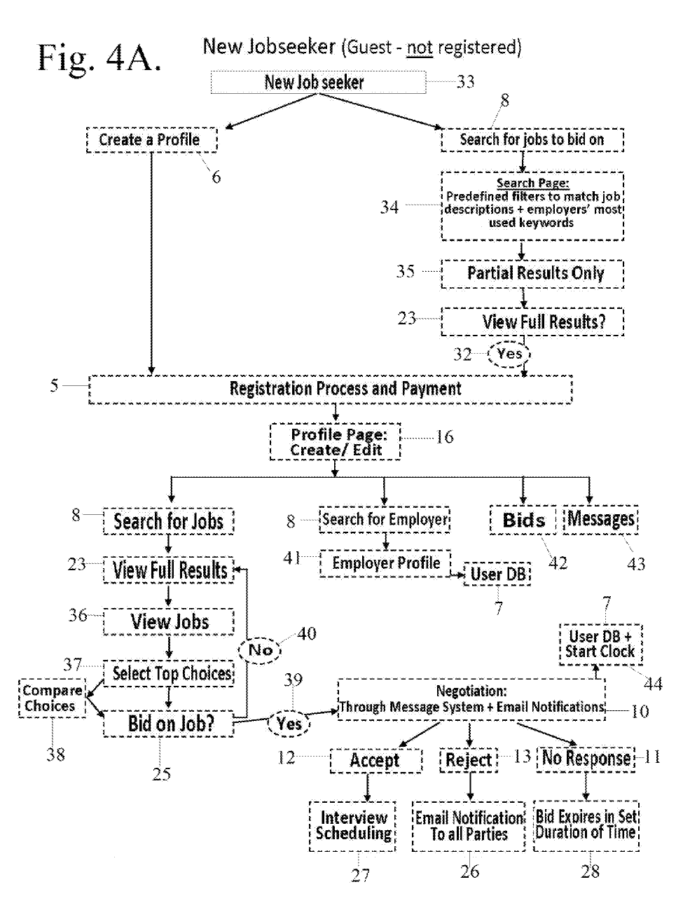

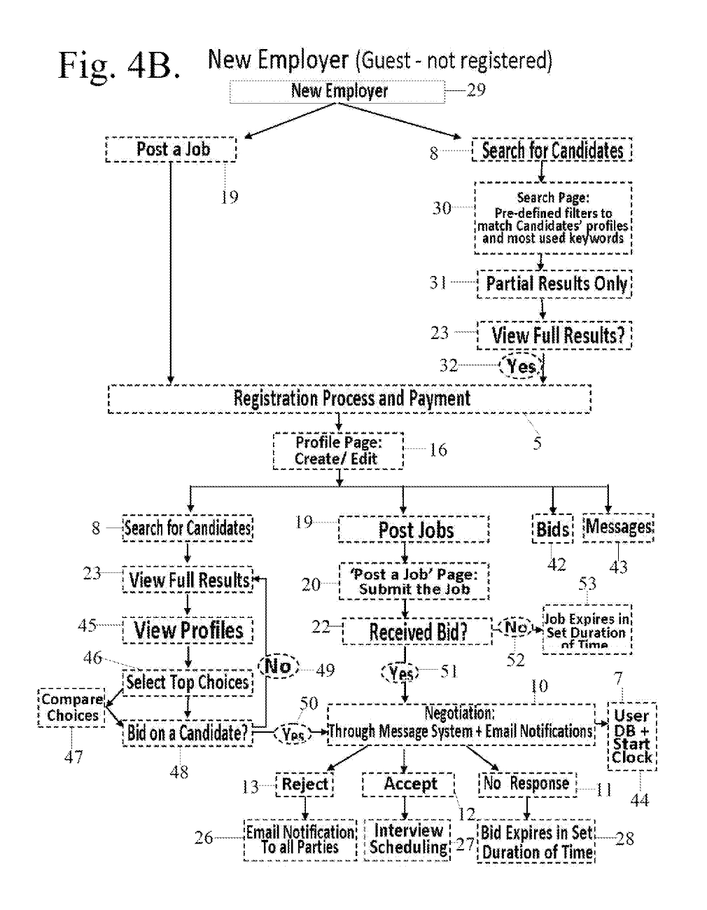

FIG. 4A is a flow diagram representing an embodiment of the present invention process from the perspective of a guest, non-registered user job seeker. In this embodiment of the present invention the new guest job seeker 33 can choose to create a profile 6 in the system and/or search for jobs to bid on 8 by accessing the search page 34, including predefined filters to match job descriptions and employers' most used keywords, to view partial search results only 35. If the new job seeker user 33 chooses 32 to view full search results 23 or create a profile 6 in the system, the registration and payment process is initiated 5, where the new user job seeker is directed to a profile page 16, where profiles can be created and edited. From the profile page 16, job seekers 33 can search for jobs 8, search for employers 8, viewing employers profiles 41 stored in the user database 7, view and access bids 42 and/or view and send messages 43 through the system. If the now registered job seeker 33 chooses to search for jobs 8, the job seeker 33 can view the full search results 23 and view jobs 36 to select top choices 37, compare choices through the system 38 and bid on jobs 25. If the job seeker 33 decides to not bid on the job 40, the job seeker 33 is redirected back to view the full search results 23. If the job seeker 33 decides to bid on a job 39, he or she is taken to the negotiation process 10 of the system, operating through system messages and e-mail notifications in the user database 7, and a timer is set 44. After engaging in the negotiation process 10, parties can ultimately accept 12 the bid and schedule interviewing 27, reject the bid 13, or not respond 11 where the bid expires in a set duration of time within the system 28. Accepting 12, rejecting 13 or not responding to a bid 11 generates an e-mail notification to all of the parties 26.

FIG. 4B is a flow diagram representing an embodiment of the present invention process from the perspective of a guest, non-registered user employer. In this embodiment of the present invention the new guest employer 29 can post a job 19 in the system and/or search for candidates 8 by accessing the search page 30, including predefined filters to match candidates profiles and most used keywords, to view partial search results only 35. If the new employer user 29 chooses 32 to view full search results 23 or post a job 19 in the system, the registration and payment process is initiated 5, where the new user employer 29 is directed to a profile page 16, where profiles can be created and edited. From the profile page 16, employers 33 can search for candidates 8, post jobs 19 through the system's job posting page 20, view and access bids 42 and/or view and send messages 43 through the system. If the now registered employer 29 chooses to search for candidates 8, the employer 29 can view the full search results 23 and view candidate profiles 45 to select top choices 46, compare choices through the system 47 and bid on candidates 48. If the employer 29 decides to not bid on the candidate 49, the employer 29 is redirected back to view the full search results 23. Further, if the employer 29 does not receive a bid 52 in a certain amount of time, the job expires 53 in the system. If, however, the employer 29 receives a bid 51 or bids on a candidate 50 the negotiation process 10 of the system is initiated, operating through system messages and e-mail notifications in the user database 7, and a timer is set 44. After engaging in the negotiation process 10, parties can ultimately accept 12 the bid and schedule interviewing 27, reject the bid 13, generating an e-mail notification to the parties 26 or not respond 11 where the bid expires in a set duration of time within the system 28.

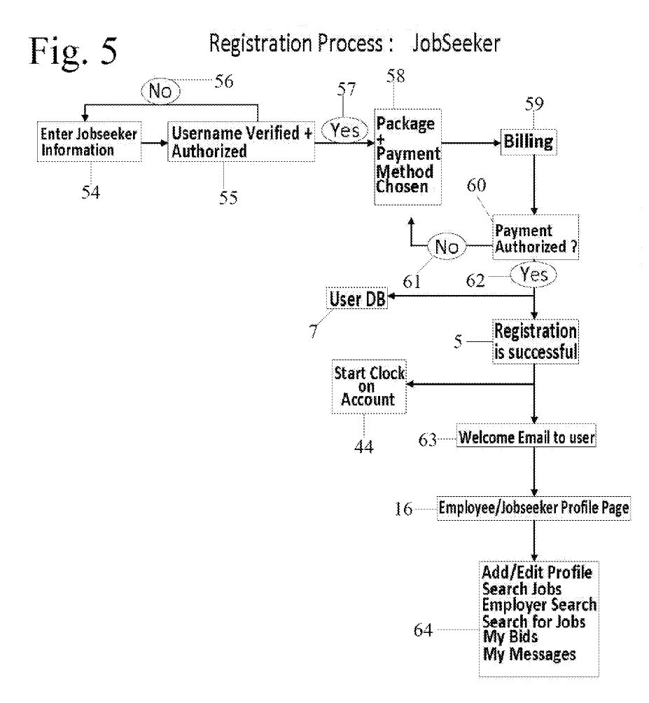

FIG. 5 displays a flow diagram representing an embodiment of the registration process the present invention from the perspective of a job seeker. Registration begins through the system when a jobseeker enters his or her information 54 in the system, wherein his or her username is verified and authorized 55. If authorization and verification fail 56, the job seeker user is redirected to enter login information 54. If authorization and verification is successful 57, the package of system services and payment method are chosen 58, and billing 59 takes place, directing users to a payment authorization 60. If payment is not authorized 61, the user is redirected to the package of system services and payment method page 58. If payment is authorized 62, the information is saved in the user database 7 and registration is successful 5, starting a clock timer on the account 44, and the user receives a welcome email 63 and is directed to the employee/jobseeker profile page 16, where the job seeker can add or edit profiles, search jobs and employers, and review and send bids and messaging through the system 64.

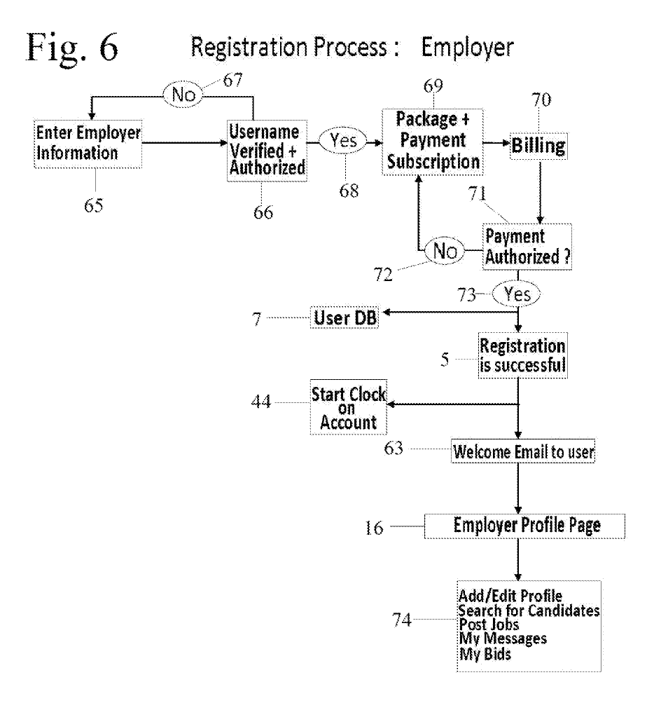

Similarly, FIG. 6 is a flow diagram representing an embodiment of the registration process the present invention from the perspective of an employer. Registration begins through the system when an employer enters information 65 in the system, wherein employer's username is verified and authorized 66. If authorization and verification fail 67, the employer user is redirected to enter login information 65. If authorization and verification is successful 68, the package of system services and payment method are chosen 69, and billing 70 takes place, directing users to a payment authorization 71. If payment is not authorized 72, the user is redirected to the package of system services and payment method 69. If payment is authorized 73, the information is save in the user database 7 and registration is successful 5, starting a clock timer on the account 44, and the user receives a welcome email 63 and is directed to the employer profile page 16, where the employer can add or edit profiles, search for candidates, post jobs, and review and send bids and messaging through the system 74.

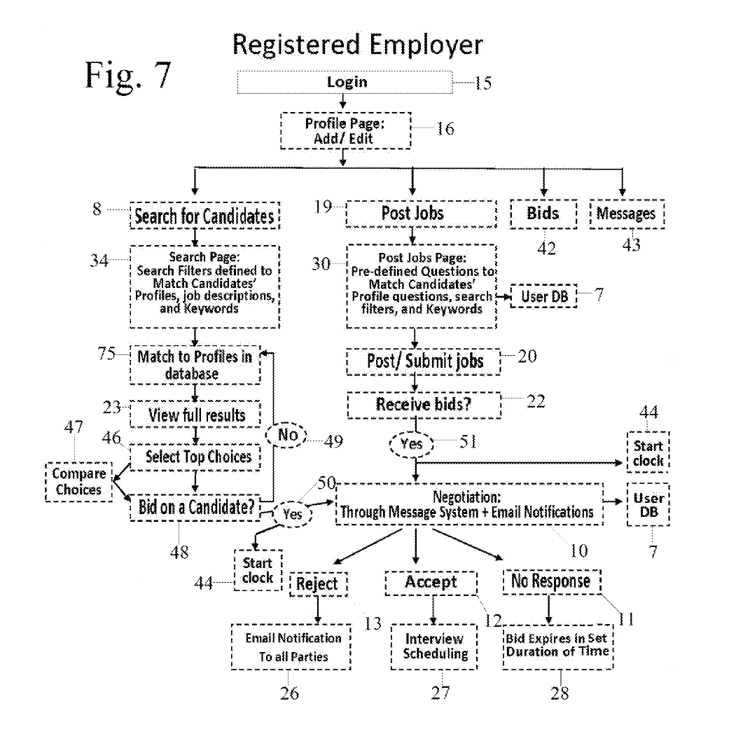

The flow diagram of FIG. 7 shows an embodiment of the system of the present invention from the access of a registered employer user. First employer logs in 15 to the system to access the employer profile page 16, where profiles can be added and/or edited. After profile access creation or editing 16, the employer can search for candidates 8, post jobs 19, access or submit bids 42 and/or send, access or delete messages 43. From the profile 16, the employer can search for candidates 8, by accessing a search page 34 where search filters are pre-defined to match candidates' profiles, job descriptions and key words/terms. Searches 34 are matched to profiles stored in the system database 75. Employers can view full search results 23, select top choices 46 to compare choices 47 in the system and/or bid on a candidate 48, where bidding on a candidate starts the clock timer 44. If an employer does not bid on a candidate 49, the employer is taken back to matched profiles in the database 75. If the employer bids 50 on a candidate, the negotiation process 10 of the system is initiated implementing system messages and e-mail notifications in the user database 7. After engaging in the negotiation process 10, parties can ultimately accept 12 the bid and schedule interviewing 27, reject the bid 13, generating an e-mail notification to the parties 26 or not respond 11 where the bid expires in a set duration of time within the system 28, such as, for example within 30 days. Another function the system allows for the registered employer to post jobs 19, through a post jobs page 30 including pre-defined questions to match candidates' profile questions, search filters and keywords, which is stored in a user database 7. The employer can post and submit jobs 20 to receive bids 22. When the employer receives a bid or bids 51, the clock is started for each bid 44. The parties enter the negotiation process 10 of the system using messages and e-mail notifications, storing information in the user database 7. After engaging in the negotiation process 10, parties can ultimately accept 12 the bid and schedule interviewing 27, reject the bid 13, generating an e-mail notification to the parties 26 or not respond 11 where the bid expires in a set duration of time within the system 28.

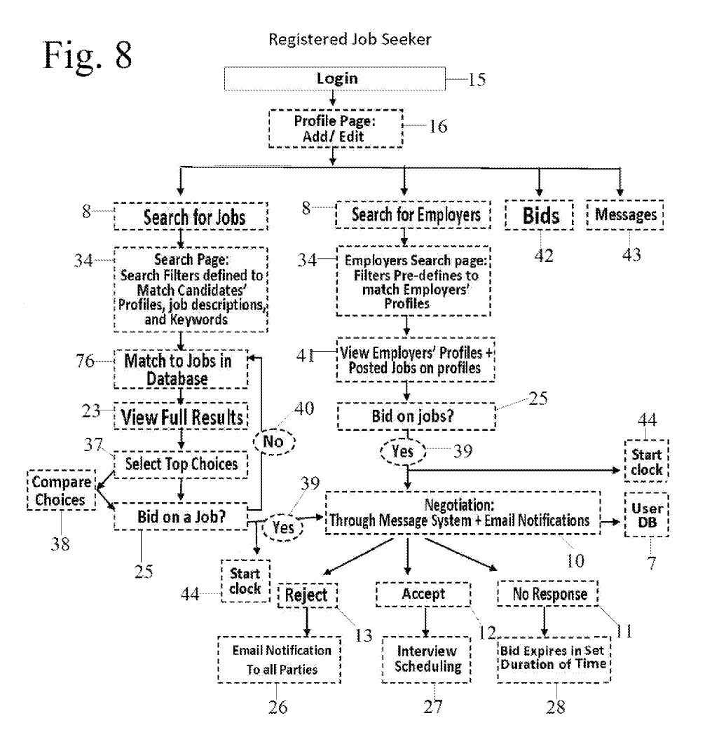

The flow diagram of FIG. 8 shows an embodiment of the system of the present invention from the access of a registered job seeker user. First the job seeker logs in 15 to the system to access the job seeker profile page 16, where profiles can be added and/or edited. After profile access creation or editing 16, the Job seeker can search for jobs 8, search for employers 8, access or submit bids 42 and/or send, access or delete messages 43. From the profile 16, the job seeker can search for jobs 8, by accessing a search page 34 where search filters are defined to match employers' job post questions, and most used key words in their industry. Searches 34 are matched to profiles stored in the system database 76. Job seekers can view full search results 23, select top choices 37 to compare choices 38 in the system and/or bid on a job 25, where bidding on a job starts the clock timer 44. If job seeker does not bid on a candidate 40, the job seeker is taken back to matched profiles in the database 76. If the job seeker does bid 39 on a job, the negotiation process 10 of the system is initiated implementing system messages and e-mail notifications in the user database 7. After engaging in the negotiation process 10, parties can ultimately accept 12 the bid and schedule interviewing 27, reject the bid 13, or not respond 11 where the bid expires in a set duration of time within the system 28. Accepting 12, rejecting 13 or not responding to a bid 11 generates an e-mail notification to all of the parties 26. From the profile 16, the job seeker can also search for employers 8 accessing an employer search page 34 including filters which are pre-defined to match employers' profiles, search filters and keywords, which is stored in a user database 7. The job seeker can view employers' profiles and posted jobs 41, and decide whether to bid on a job or jobs 25. If the job seeker bids on a job 39, the clock is started 44 and the parties enter the negotiation process 10 of the system using messages and e-mail notifications, storing information in the user database 7. After engaging in the negotiation process 10, parties can ultimately accept 12 the bid and schedule interviewing 27, reject the bid 13 or not respond 11 where the bid expires in a set duration of time within the system 28, and wherein all generate an e-mail notification to all parties 26.

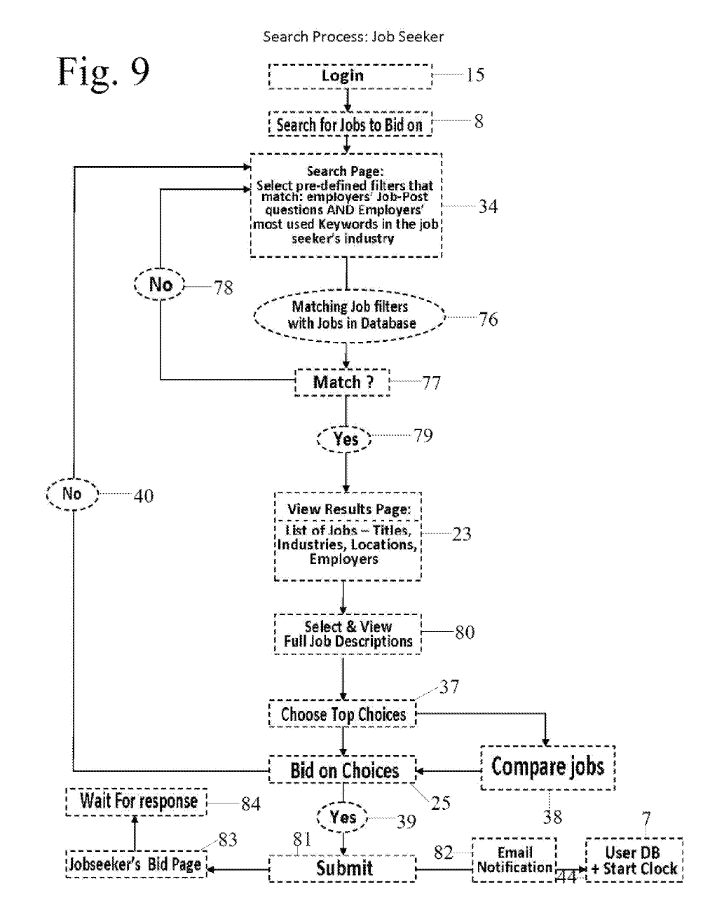

FIG. 9 is a flow diagram representing an embodiment of the search process of the present invention from the perspective of a job seeker. In this embodiment, a job seeker logs into the system 15, searches for jobs to bid on 8, accessing a search page 34 where he or she can select pre-defined filters that match employers' job post questions and employers most used keywords in the job seekers' industry. Then the system matches job filters with jobs in the database 76, running software to generate a match 77. If there is no match 78, the job seeker is redirected to the search page 34 to create a new search. If there is a match 79, the job seeker views a results page 23, which includes a list of criteria including job titles, industries, locations, employers and other relevant job related information. Job seekers can select and view full job descriptions 80, choose top choices 37, compare jobs 38 and/or bid on choices 25. If job seekers do not bid 40 on a job, they are redirected back to the search page 34. If job seekers bid on choices 39, they submit a bid 81, which becomes stored in a jobseeker bid page 83, the job seeker will then wait for a response 84, and the job seeker receives an email notification 82 of the bid submission, the submission is stored in the user database 7 and the clock is started 44.

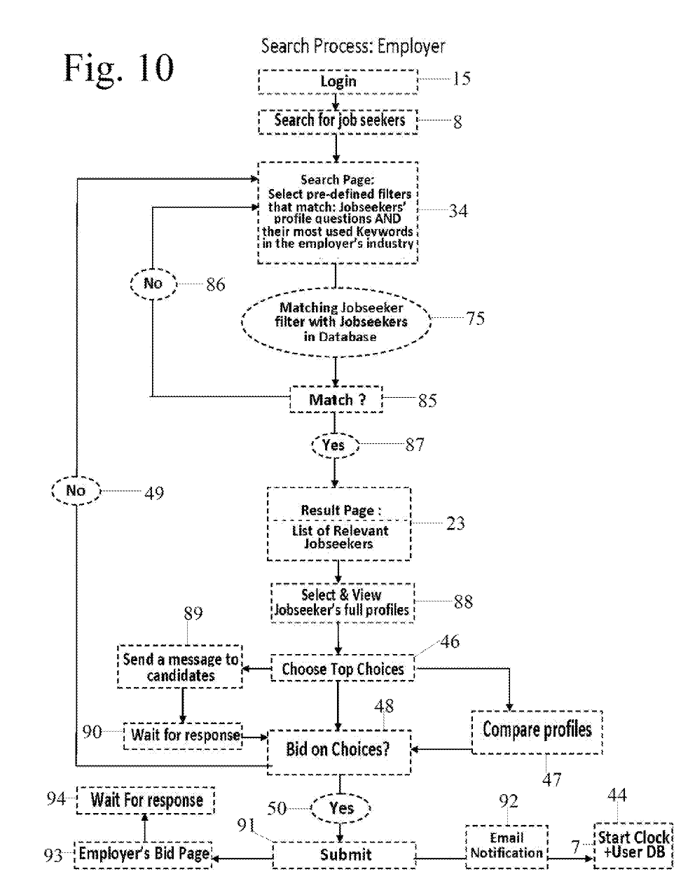

FIG. 10 is a flow diagram representing an embodiment of the search process of the present invention from the perspective of a job seeker. In this embodiment, an employer logs into the system 15, searches for jobs seekers 8, accessing a search page 34 where the employer can select pre-defined filters that match job seekers' profile questions and most used keywords in the employers' industry. Then the system matches job seeker filters with job seekers in the database 75, running software to generate a match 85. If there is no match 86, the employer is redirected to the search page 34 to create a new search. If there is a match 87, the employer views a results page 23, which includes a list of relevant job seekers. Employers can select and view full job seekers profiles 88, choose top choices 46, compare job seekers 47 and/or bid on choices 48. Employers can select and view job seekers profiles 88, chose top choices 46, and employers have the option to initiate messages to job seeker candidates 89, then wait for a response 90, and bid on candidates 48. If employers do not bid 49 on a job seeker, they are redirected back to the search page 34. If employers do bid on a candidate or candidates 50, they submit a bid 91, which becomes stored in an employer's bid page 93, the employer will then wait for a response 94, and the employer receives an e-mail notification 92 of the bid submission, the submission is stored in the user database 7 and the clock is started 44.

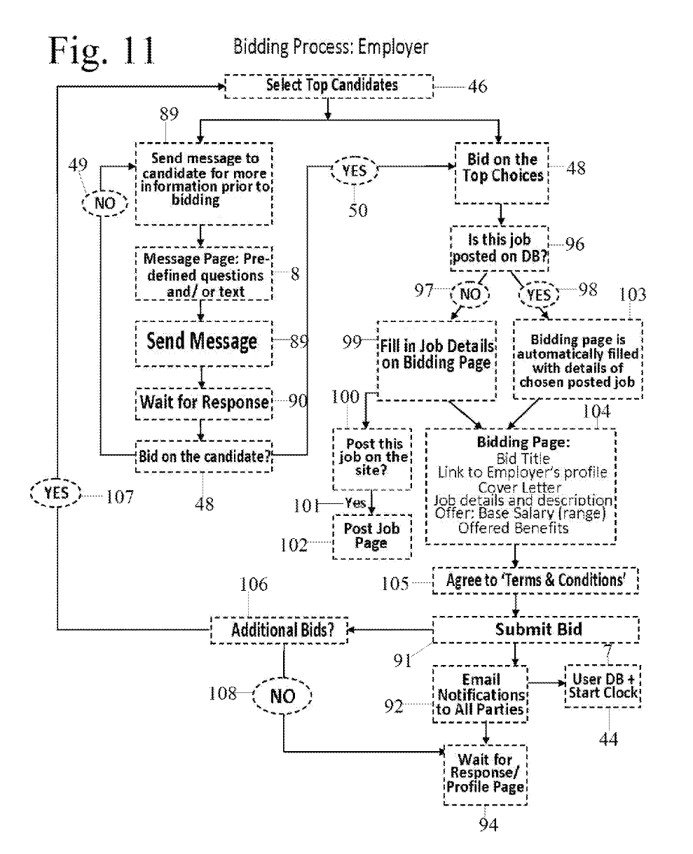

An embodiment of the bidding process of the present invention from the perspective of an employer user is displayed in FIG. 11. This embodiment of the process begins with an employer selecting top candidates 46, and having the option to send a message or messages to candidate for more information prior to bidding 89 going through a process which can assist an employer in deciding whether to bid on a candidate or the employer can just place bid on a candidate 48. If the employer decides to send a message or messages to the candidate to obtain more information prior to bidding 89, the employer enters a message page 95 containing predefined questions and/or text, and can send a message 89, wait for a response 90 and then decide whether or not to bid on a candidate 48. If the employer decides not to bid on the candidate 49, the employer can decide whether to send additional messages to candidates 89. If the employer decides to bid on a candidate 50 after going through the messaging process 48, or decides to bid on a candidate 48 after the selection of top candidate choices 46, employers are asked whether this particular job is already posted on the database 96. If the job is not posted on the database 97, the employer can fill in job details on the bidding page 99 and either choose 101 to post the job on the system web site 100, posting a job page 102 or enter the bidding page 104. If the job is posted on the database 98, the bidding page is automatically filled with details of the chosen posted job 103, and employer is taken to the bidding page 104. The bidding page 104 provides a bid title, link to the employer's profile, cover letters, job details and description, offer including base salary, salary ranges, benefits offered and etc. The bidding page 104 directs users to agree to the terms and conditions 105, which once accepted allow users to submit a bid 91. After bid submission 91, the user receives an e-mail notification 92, which saves information in the user database 7 and starts the clock 44, and the employer must now wait for a response 94 and can return to the profile page. Also, after bid submission 91, the employer can decide whether to make additional bids 106. If the employer decides to not place additional bids 108, the employer must wait for a response 94 and can return to the profile page. If the employer decides to place additional bids 107, the employer can go back to search results and select top candidates 46 and start the bidding process again.

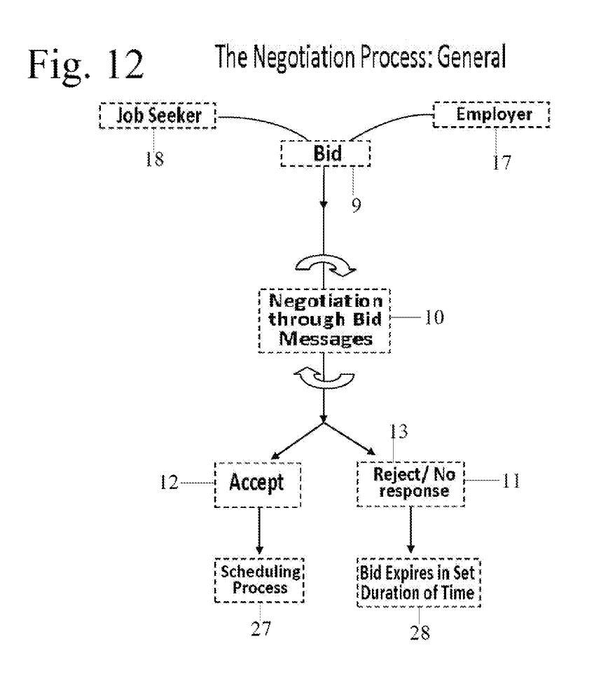

FIG. 12 is a flow diagram displaying a broad overview of an embodiment of the negotiation process of the present invention. In this embodiment of the present invention, the job seeker 18 and the employer 17 place or respond to bids 9, initiating the negotiation process through bid messages 10. After the negotiation process 10, the bid can be accepted 12, and the interview scheduling process can begin 27 or the bid can be rejected 13 or not responded to by a party 11, wherein the bid expires in the system after a set duration of time.

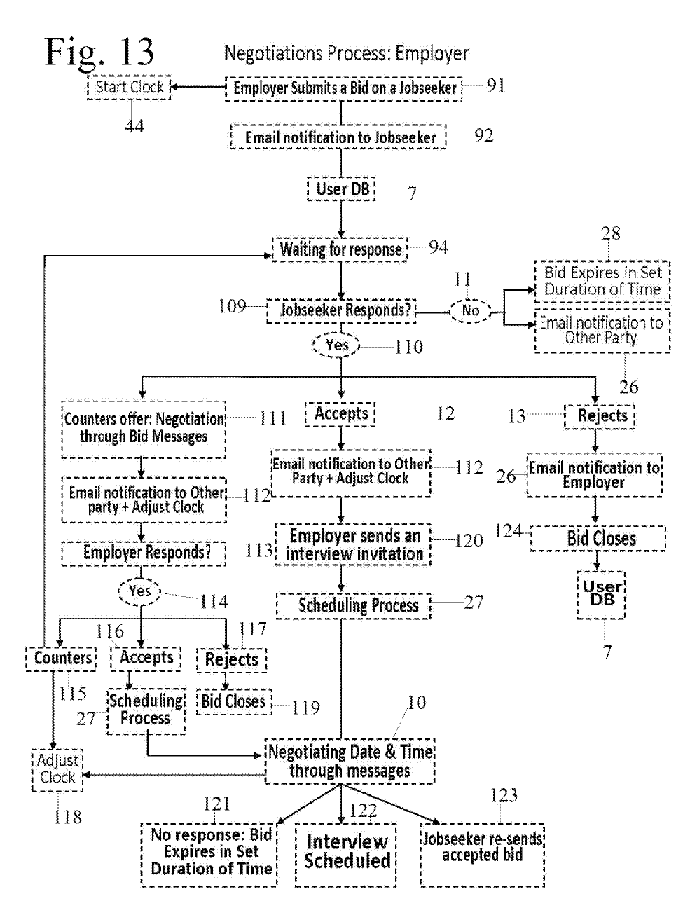

FIG. 13 is a flow diagram representing an embodiment of the negotiation process of the present invention from the perspective of an employer user. This embodiment of the negotiation process is initiated when the employer submits a bid on a job seeker 91, starting the clock timer 44. An email notification is sent to the jobseeker 92 and information is saved in the user database 7, and the employer waits for a response 94 from the jobseeker 109. If the jobseeker does not respond 11, the bid expires in a fixed duration of time 28 and the parties are provided an email notification 26 of the bid expiration. If the job seeker does respond 110, the job seeker may respond by providing a counter offer 111, accept the offer 12 or reject the offer 13. If the jobseeker counter offers, negotiations can be initiated 111 and bid messages can be sent, generating an email notification to the employer and adjustment of the system's clock timer 112, allowing employer to respond 113. If the employer responds 114 to the counteroffer, the employer may counter offer 115, adjusting the system timer 118 and putting the employer in a position of waiting for another response from the job seeker 94, and reinitiating the negotiation cycle. The employer may respond 114 by accepting 116 the bid, initiating the interview scheduling process 27 and negotiation process (for date and time) 10 through messages, where no response from the job seeker causes the bid to expire within a set duration of time 121, or a job seeker responds and an interview is scheduled 122 or a jobseeker re-sends an accepted bid 123 (as a reminder). If the employer responds 114 by rejecting 117 the counteroffer the bid closes 119. A job seeker may also respond 110 to an employers' bid 91, by accepting the bid 12, generating an email notification to the employer and adjustment of the system timer 112, after which the employer sends an interview invitation through the system 120 and the parties enter the scheduling process 27 and negotiation process 10 through messages, where no response from the job seeker causes the bid to expire within a set duration of time 121, or a job seeker responds and an interview is scheduled 122 or a jobseeker re-sends and accepted bid 123. Finally, a job seeker may also respond 110 to an employers' bid 91, by rejecting the bid 13, wherein the employer receives an email notification 26, the bid closes 124, and information is stored in the user database 7.

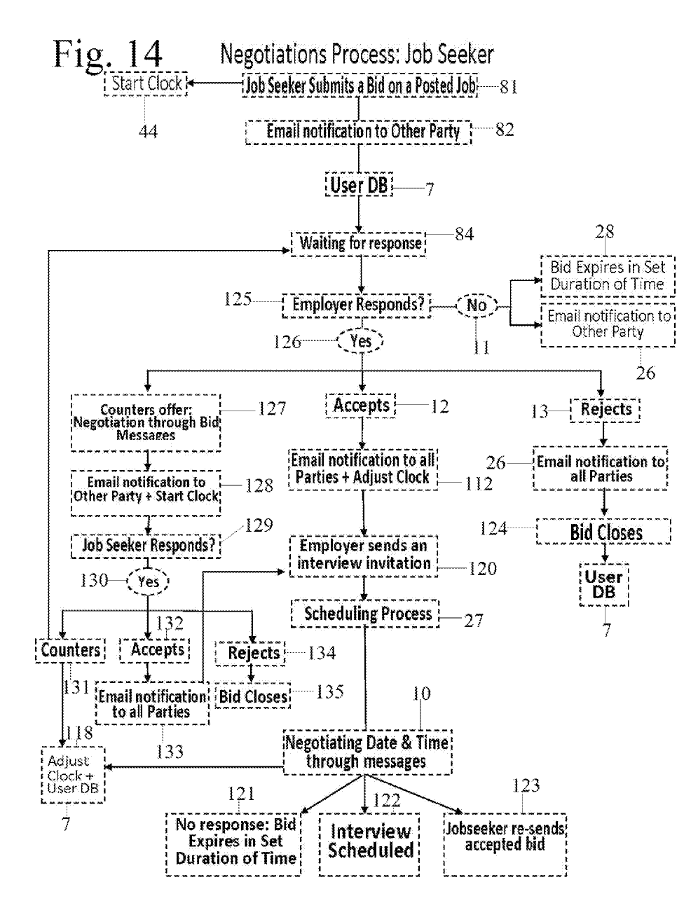

FIG. 14 is a flow diagram representing an embodiment of the negotiation process of the present invention from the perspective of a job seeker user. This embodiment of the negotiation process is initiated when the job seeker submits a bid on a posted job 81, starting the clock timer 44. An email notification is sent to the employer 82 and information is saved in the user database 7, and the job seeker waits for a response 84 from the employer 125. If the employer does not respond 11, the bid expires in a fixed duration of time 28 and the other party (job seeker) is provided an email notification 26 of the bid expiration. If the employer does respond 126, the employer may respond by providing a counter offer 127, accept the offer 12 or reject the offer 13. If the employer counter offers, negotiations can be initiated 127 and bid messages can be sent, generating an email notification to the job seeker and adjustment of the system's clock timer 128, allowing job seeker to respond 129. If the job seeker responds 130 to the counteroffer, the job seeker may counter offer 131, adjusting the system timer 118, storing information in the user database 7 and putting the job seeker in a position of waiting for another response 84, thereby reinitiating the negotiation cycle. The job seeker may respond 130 to the employers' counteroffer 127 by accepting 132 the offer, generating an email notification to the employer 133, and then placing the bid in a condition for the employer to send the job seeker an interview invitation, which includes the scheduling options for an interview 120, after which the parties enter the interview scheduling process 27, and then the negotiation process 10 through messages, where no response from the job seeker causes the bid to expire within a set duration of time 121, or a job seeker responds and an interview is scheduled 122 or a jobseeker re-sends and accepted bid 123. Finally, the job seeker may respond 130 to the employers' counteroffer 127 by rejecting 134 the offer, closing the bid 135.

If the employer does respond 126 by accepting the job seeker's initial bid 12, email notification is provided to the job seeker through the system and the system timer is adjusted 112. The employer sends an interview invitation 120, and then the parties enter scheduling process 27 and the negotiation process 10 through messages, where no response from the job seeker causes the bid to expire within a set duration of time 121, or a job seeker responds and an interview is scheduled 122 or a jobseeker re-sends and accepted bid 123. If the employer responds 126 by rejecting 13 the job seeker's initial bid 12, email notification is provided to all parties through the system 26 and the bid closes 124 and information is saved in the user database 7.

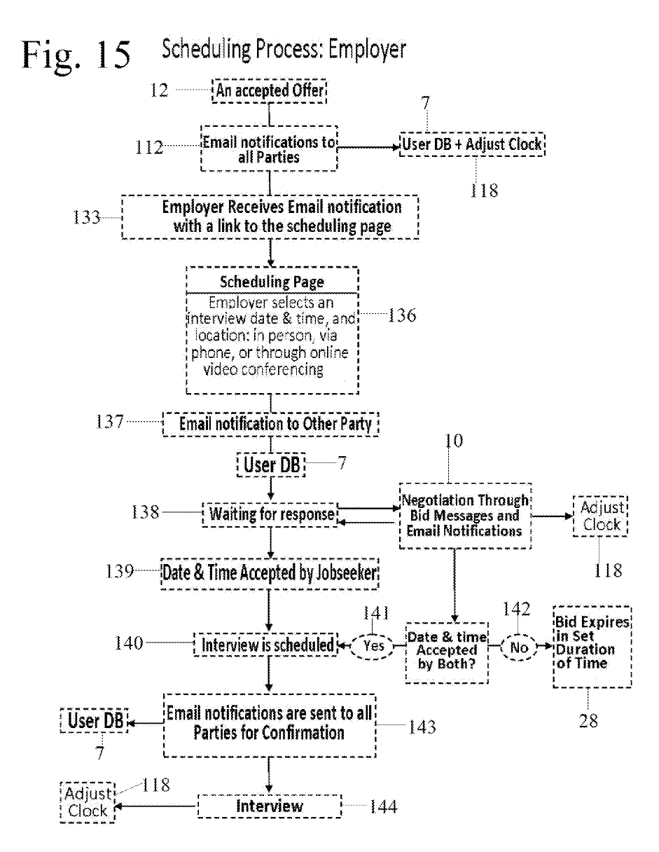

An embodiment of the scheduling process of the present invention from the perspective of an employer user is found in FIG. 15. The scheduling process begins with an accepted offer 12, creating an e-mail notification to parties 112, storing data in the user database 7 and adjusting the system timer clock 118. The employer either receives an email notification with a link to the scheduling page 133 or is automatically directed to the scheduling page after accepting a bid. Then the employer is directed to the scheduling page 136, where the employer selects interview parameters including dates, times, locations, whether the interview will be held in person, or online through the system via video conferencing, etc. Once interview parameters and alternative options are selected by the employer 136, an email notification containing this information is sent to the other party (jobseeker) 137 and stored in the user database 7. Then the employer must wait for a response 138 from the job seeker. If the interview scheduling is accepted by the jobseeker 139, the interview is scheduled 140, email notifications are sent to the employer and jobseeker for confirmation 143, information is saved in the user database 7 and the interview takes place 144, adjusting the system clock 118. If the job seeker instead responds to the proposed interview with negotiations through bid messages and email notifications 10, adjusting the system clock 118, placing the interview parameters in a condition to be accepted by both parties 141. If both parties accept the interview 141, the interview is scheduled 140, email notifications are sent to the employer and jobseeker for confirmation 143, information is saved in the user database 7 and the interview takes place 144, adjusting the system clock 118. If the interview parameters are not accepted by both parties 142, the bid expires in the system within a set duration of time 28.

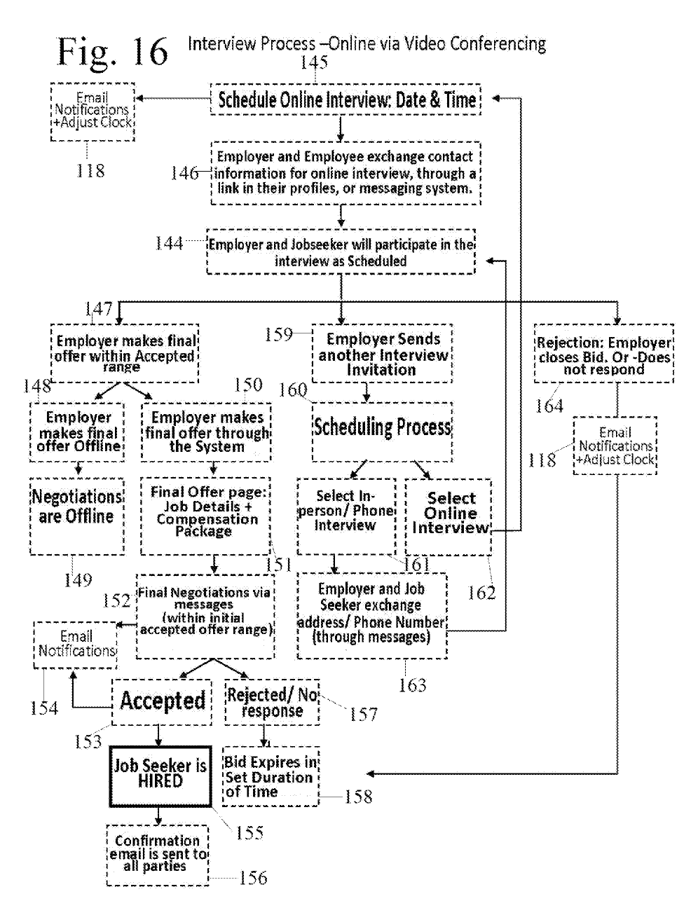

An embodiment of the online interview process of the present invention is displayed in FIG. 16. In this embodiment, the online interviewing process through video conferencing is initiated when the parties schedule an online interview 145, including the date and time of the interview. Scheduling of the online interview generates email notifications to the parties and adjusts the system's time clock 118. Next the employer and employee exchange contact information for the online interview through links in their profiles or through the messaging system 146. The employer and jobseeker participate in the interview as scheduled either through the system with a separate page opening for the video conferencing, or through a separate video conferencing website 144. After the interview the employer may make a final offer within the accepted job parameters and salary range 147, employer may send another interview invitation to the job seeker 159 or the employer may reject or not respond to the job seeker 164, closing the bid or resetting the system timer for bid expiration in the system 118.

If the employer responds by making a final offer within the accepted job parameters and salary range 147, the employer may make the final offer offline 148, and negotiation will take place offline 149 or the employer may make a final offer online through the system 150, where the employer enters the final offer page 151, full with job details and compensation package information. Final negotiations take place via system messages within the initial accepted offer range 152. If the final offer is accepted 153, email notifications are sent to the parties 154 through the system, the job seeker is hired 155 and confirmation email is sent to both users 156. If the final negotiations 152 are rejected or there is no response 157, the offer expires in within a set amount of time 158.

If the employer responds by sending the job seeker another interview invitation 159, the scheduling process is reinitiated 160, and parties can select an in person or phone interview 161 where the employer and jobseeker exchange contact information 163, or the parties can select an online interview 162, where the parties reinitiate the scheduling process for the online interview 145.

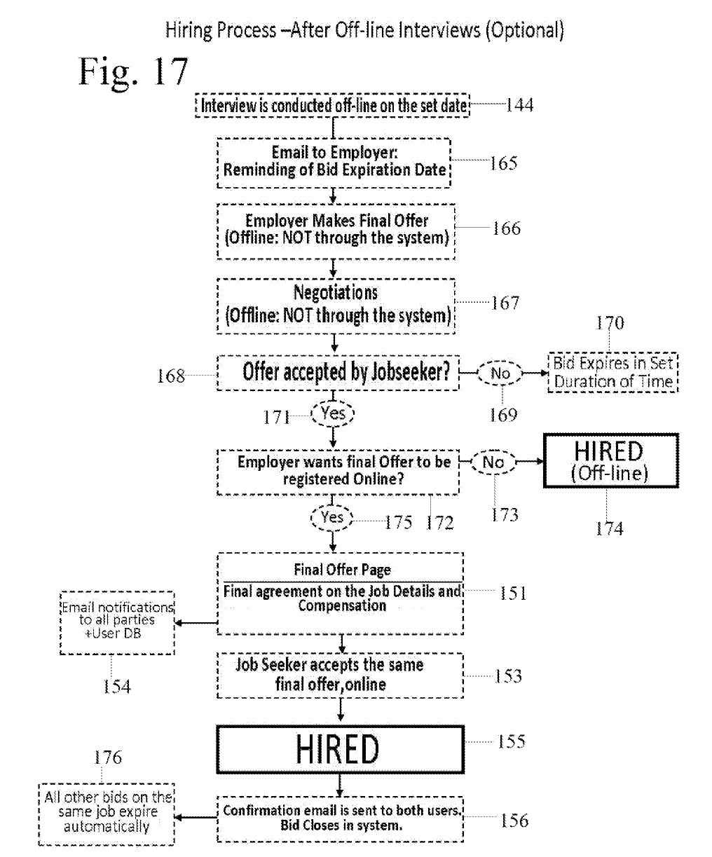

Finally, FIG. 17 provides a flow diagram representing an embodiment of the offline interview process of the present invention and optional online system process. First, the interview is conducted offline at the set parameters chosen by the parties 144, including time, date, location, etc. The system provides email notifications to the employer reminding the employer of the bid expiration date 165. The employer makes the final offer offline 166 and then negotiations also take place offline 167, putting the offer in a condition to be accepted by the job seeker 168. If the offer is not accepted by the job seeker 169, the bid expires in a set amount of time from the interview date 170. If the offer is accepted by the jobseeker 171, the employer has the option of choosing whether the final offer will be registered online 172. If the employer does not want the final offer to be registered online 173, the job seeker is hired offline 174. If the employer chooses for the final offer to be registered online 175, the employer is directed to a final offer page within the system 151 that includes relevant job information including the final agreement on the job details and the compensation. E-mail notifications are sent to both users and stored in the user database 154. Then the job seeker accepts the final offer online 153 and becomes hired 155 through the online system. A confirmation email is sent to both users and the bid closes in the system 156, while all other bids in the system for the same job expire automatically 176, as the job has been filled.

In the preferred embodiment of the invention, when a bid is accepted and the formal offer was accepted, the process is completed. All other bids for that position expire within a set duration of time, such as within 30 days of their issue, automatically. A newly hired employee may leave his or her profile where their profile is still searchable, and is encouraged to change status to ‘employed.’

The advantages of the present invention include, without limitation the ability to save parties time, money and resources in finding an appropriate match, streamlining the process of matching job seekers to employers, and allowing parties to use non-traditional multimedia data to present themselves, their qualifications and skills, and to communicate with other parties through the system.

Since the system of the present invention requires users to engage in offers and negotiations much earlier in the process, as a condition to receiving interviews, each party receives guidance on where to invest time. The system also provides employers the opportunity to negotiate the best ‘deal’ (best candidates for lowest possible offer), and make sure they interview only the candidates who fit all their needs, including salary range. A unique feature of the process of the present invention is the ability of employers to bid on employees and have the negotiations earlier in the process. This feature allows job seekers to apply less, and even to be passive, allowing offers to be made to them. Further, the system provides a way for employees to stop applying to many jobs and to respond to and even compare bids received. A benefit of the system for employees is that the system provides a way for employees to negotiate salary without having to be the first to provide a salary, therefore providing both parties a way to decide where to invest time and where to interview, based on the offer. Employers benefit by being able to give offers to job seekers and by having a way now to negotiate earlier, more efficiently, including more quickly, and ensuring they interview not only the most qualified candidates, but only the ones that accepted their bids. The system provides employers to get a great ‘deal’ through negotiations, where employers can obtain great candidates with low offers. Finally, employers can attract very passive, highly desired, but non-responsive candidates with their offers.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

The invention is claimed as follows:

1. A method, comprising: interfacing with end users in a network, receiving profile data from end users to be stored in a database connected with a central website, wherein said profile data includes multimedia information and is used to form customized user profiles; providing pre-determined filters for said end users to use in creating said profiles to facilitate matching; providing search functions wherein search functions contain pre-determined filters for searching and wherein said pre-determined search filters correlate to said pre-determined filters used in profile creation to facilitate matching of end users; responding to searches by providing one category of end users with resulting matches of another category of end users based on relevancy of matching of pre-determined profiles and filters, wherein the resulting matches are ranked with the greatest number of matching pre-determined search and profile filters being more prominently displayed; and providing a network platform where negotiations between said end users occur prior to or without scheduling an interview, wherein placement of an initial bid by one of said end users on another category of said end users' profile/listing can be accepted, rejected or counter offered against, wherein counteroffer bids allow for negotiations between said end users, where negotiations are in the form of bids setting out the terms or range of terms of a potential agreement, which when accepted by said end users make the terms of said bids binding for future negotiations, and wherein the final terms of negotiation bids will be binding upon all users only after a final agreement is entered into and agreed to by said end users.

2. The method of claim 1, wherein the central website is associated with a job seeking and placement service, a land lord and tenant matching service, a travel service, or a real estate finding service.

3. The method of claim 1, further comprising providing an internal messaging system for end user communication.

4. The method of claim 1, further comprising providing end users with video conferencing to enable end users to engage in video interviewing and other video communications.

5. The method of claim 1, further comprising providing end users with the feature of active or passive profile status.

6. The method of claim 1, further comprising providing end users with a scheduling module wherein said end users can schedule interviews online through the system or schedule interviews to be held outside of the system.

7. The method of claim 1, wherein said network platform for negotiations further comprises providing end users with the opportunity to place and receive multiple bids at a time on different categories of end users, wherein the terms of said bids will be binding on said end users once accepted such that said end users cannot negotiate outside of the accepted bid range, and the bid itself will become binding on said end users only when end users agree to enter into a final agreement with one another.

8. A system comprising: a central website operable to interface with end users, wherein said website comprises a database comprising multimedia data related to end users, a question and response module comprising filters using pre-matched fields to be completed in creation of profiles of said end users to facilitate matching of end users with the maximum relevancy, a profile builder where profiles can be designed and customized with uploads of backgrounds, fonts, photos, pictures, videos, special designs and an editing option, a searching module comprising selection of said pre-matched fields to locate other end users, a ranking module where results are displayed according to a matching hierarchy wherein most relevant results are displayed first and other matches are displayed in order from most relevant to least relevant based on pre-defined filters in profiles and searches, a communication module comprising data end users can send to one another, an interview module allowing for interviewing, a scheduling module wherein end users can schedule interviews online or offline, and a negotiation module wherein end users negotiate terms of an agreement with different categories of end users through placing and/or receiving bids prior to scheduling an interview or without interviewing at all, wherein bids placed can be accepted, rejected or counter offered against by the receiving end user and wherein placement of an initial bid by an end user on another end user's profile/listing allows for negotiations, and said negotiations are in the form of bids setting out the terms or range of terms of a potential agreement, which when accepted by said end users make the terms of said bids binding for future negotiations, and wherein the final terms of negotiation bids will be binding upon all users only after a final agreement is entered into and agreed to by said end users.

9. The system of claim 8, wherein the central website is associated with a job seeking and placement service, a land lord and tenant matching service, a travel service, or a real estate finding service.

10. The system of claim 8, wherein the central website further comprises a job seeking and placement service, wherein end users can place and receive multiple bids for compensation, wherein employer end users can place bids for compensation on selected job seeker end users, and job seeker end users can place bids for compensation on selected employer end user's job postings.

11. The system of claim 8, wherein the communication module further comprises providing end users with the capabilities to instant message, chat, send internal e-mail correspondence, and use video conferencing.

12. The system of claim 8, wherein user profiles further comprise either an active or passive status, reflecting whether they are actively searching for and placing bids or passively waiting for offers.

13. A system, comprising: a central website operable to interface with job seeker and/or employer end users, wherein said website comprises a database comprising multimedia data related to at least one job seeker and at least one employer job listing; a question and response module comprising filters using pre-matched fields to be completed in creation of both job seeker and employer/job profiles; a profile builder where profiles can be designed and customized with uploads of backgrounds, fonts, photos, pictures, videos, special designs and an editing option, a searching module comprising selection of said pre-matched fields to locate job seeker candidates by employer end users or jobs by job seeker end users; a ranking module were results are displayed according to matching hierarchy; a communication module comprising data job seeker end users and/or employer end users can send to one another regarding information, job descriptions, negotiations, and bids for the other in regards to an employment relationship, allowing for negotiation on the terms of an employment agreement; an interview module comprising notification of at least one job seeker by an employer of interest in an interview, which can be implemented in person or through the system; a scheduling module wherein job seekers and employers can schedule interviews online or offline; and a negotiation module wherein job seeker end users and employer end users negotiate terms of an employment agreement early in the application process, prior to scheduling an interview or without interviewing at all, and wherein said job seeker end users and employer end users can accept, reject, and/or negotiate the terms of an employment agreement through bidding counteroffers, wherein negotiations are in the form of bids setting out the terms and/or range of terms of a potential employment agreement, which when accepted by job seeker end users and employer end users make the terms of said bids binding for future negotiations, and wherein the final terms of bids will be binding upon job seeker end users and employer end users only after a final agreement is entered into and agreed to by all said job seeker end users and employer end users.

14. The system of claim 13 wherein the communication module comprises providing end users with the capabilities to instant message, chat, send internal e-mail correspondence, and use video conferencing.

15. The system of claim 13, wherein user profiles further comprise either an active or passive status, reflecting whether they are actively searching for and placing bids or passively waiting for offers.

16. The system of claim 13, wherein said employer job listings and said employer/job profiles are for full time employment positions.

17. A method, comprising: interfacing with one or more job seeker and/or employer end users in a network, receiving profile data from job seeker and/or employer end users to be stored in a database connected with a central website, wherein said profile data includes multimedia information; providing pre-determined filters for said job seeker and/or employer end users to use in creating said profiles to facilitate matching of job seeker end users to employer end users; providing search functions wherein search functions contain pre-determined filters for searching wherein said pre-determined search filters correspond to said pre-determined filters used in profile creation to facilitate matching; responding to searches by providing job seeker and employer end users with matches of employer and job seeker end users respectively, wherein the highest ranked matches are based on said pre-determined filters; and providing a network platform where negotiations between said job seeker and employer end users occur prior to or without scheduling an interview, wherein said job seeker and employer end users can accept, reject, and/or negotiate the terms of an employment agreement through bidding counteroffers, and wherein the bids set out the terms or range of terms of a potential employment agreement, which when accepted by job seeker and employer end users the terms of said bids becomes locked for future negotiations such that future negotiations must be made within the accepted bid terms, and wherein the final terms of bids will be binding upon job seeker end users and employer end users only after a final agreement is entered into and agreed to by all said job seeker end users and employer end users.

18. The method of claim 17, further comprising providing an internal messaging system for end user communication.

19. The method of claim 17, further comprising providing end users with video conferencing to enable end users to engage in video interviewing and other video communications.

20. The method of claim 17, further comprising providing end users with the feature of active or passive profile status.

21. The method of claim 17, further comprising providing end users with a scheduling module wherein said end users can schedule interviews online through the system or outside of the system.

22. The method of claim 17, wherein said network platform for negotiations provides end users with the opportunity to place and receive multiple bids at a time on different categories of end users, wherein the terms of said bids will be binding on said end users once accepted such that end users cannot negotiate outside of the accepted bid range, and the bid itself will become binding on said end users only when end users agree to enter into a final agreement with one another.

23. The method of claim 17, wherein said employment agreement is for a full time employment position.
